(19) United States
(12) Patent Application Publication
(10) Pub. No.: US 2024/0029171 A1
(43) Pub. Date: Jan. 25, 2024

(54) SYSTEM AND METHOD FOR INTRODUCING AN INTERACTIVE POINT-OF-SALE INTO VEHICLES

(71) Applicant: Shawn Burger, Naples, FL (US)

(72) Inventor: Shawn Burger, Naples, FL (US)

(21) Appl. No.: 18/375,570

(22) Filed: Oct. 2, 2023

Related U.S. Application Data
(63) Continuation-in-part of application No. 17/241,443, filed on Apr. 27, 2021, now abandoned.

(51) Int. Cl. G06Q 40/08; G06Q 30/0601

(52) U.S. Cl. CPC G06Q 40/08; G06Q 30/0621

(57) ABSTRACT

A method and system for introducing a point-of-sale device for engaging, interacting, and purchasing peripheral products and services directly from a vehicle wherein the products and services are uniquely matched and/or tailored to the vehicle.

### FIELD OF THE INVENTION

This invention relates generally to methods and systems used for implementing targeted advertising for the sale of products and services to individuals, and more particularly, a system and method for introducing an interactive point-of-sale system into a vehicle for selecting and purchasing services and/or products that are uniquely specified to that vehicle.

### BACKGROUND OF THE INVENTION

When purchasing products, consumers are normally offered extended warranties, service agreements, service contracts and/or maintenance agreements that protect against defects and mechanical or electrical failures. However, a dealer may not offer regulated insurance products that cover loss, damage, theft, and bodily injury.

For example, a consumer purchasing a new car may be offered an extended warranty covering mechanical breakdowns on the car. These extended warranties are not regulated and, thus, may be purchased directly through the dealer selling the car. However, the dealer may not offer or sell auto insurance or regulated forms of insurance without first acquiring an insurance license, even though insurance is required to drive a new car off the dealer's lot.

Therefore, a need exists for a system and method for introducing an interactive point-of-sale for purchasing peripheral products and services.

### SUMMARY OF THE INVENTION

The primary object of the present invention is to provide a system and method for introducing an interactive point-of-sale for purchasing peripheral products and services directly from a vehicle wherein the products and services are uniquely matched to the vehicle.

The present invention fulfills the above and other objects by providing an online point-of-sale presented through an electronic device display wherein a customer is provided control over the electronic device by the dealer during the process of purchasing an item, such as a new car.

The point of sale is preferably an interactive electronic device in a vehicle's entertainment system wherein a display in the entertainment system is a touchscreen display or a display having alternative controls for selecting icons and/or entering information through the display. The electronic device is preferably connected to the Internet and/or an equivalent wireless communication system.

During the customer's interactive experience and being provided capability for selecting and purchasing products and services via the electronic display and to navigate around and/or through one or more pages displaying options for products and/or services specific to the individual vehicle.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a diagram of an example data flow for introducing an interactive point-of-sale for purchasing peripheral products and services;

FIG. 2 is an exemplary view of a customer interface of the present invention being presented on an electronic display in a vehicle dashboard;

FIG. 2A is a magnified view along lines A-A of FIG. 2 of a customer interface of the present invention being presented on an electronic display in a vehicle dashboard;

FIG. 3 is a flow chart showing initial steps for carrying out the system and method of the present invention;

FIG. 4 is a flowchart showing steps for carrying out the system and method of the present invention after a customer has selected a dealer hyperlink; and

FIG. 5 is a flowchart showing steps for carrying out the system and method of the present invention after a customer has selected an insurance provider hyperlink.

### DESCRIPTION OF THE PREFERRED EMBODIMENTS

The method and system of the present invention is designed to provide a Graphical User Interface (GUI) within a vehicle for effectuating the purchase of one or more products that are unique to the vehicle by coupling, by a processor, a GUI to a vehicle wherein a plurality of variables unique to the vehicle are programmed into a memory that is in communication with the processor and the GUI. Then, receiving, by the processor, a request for a product entered through the GUI wherein the product is unique to the plurality of variables programmed into the GUI. Next, evaluating, by the processor, available products stored on a remote server. Then, determining, by the processor, a product that matches one or more of the variables programmed into the GUI. Next, altering, by the processor, said product to match one or more of the variables programmed into the GUI. Then, visualizing, by the processor, the product through an associated product display element on the GUI. Finally, executing, by the processor, a purchase the product represented by the associated product display on the GUI.

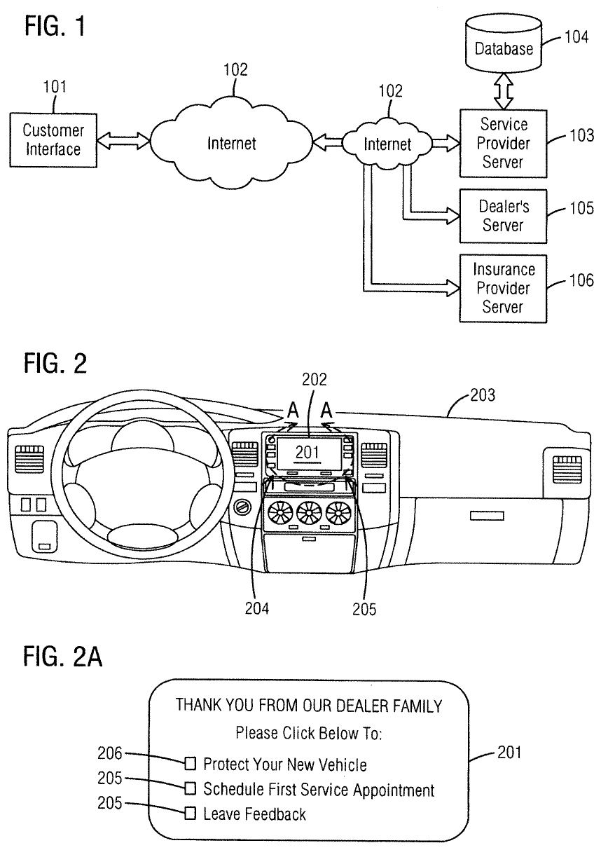

With reference to FIG. 1, a diagram of an example data flow for introducing an interactive point-of-sale for purchasing peripheral products and services is illustrated. The system and method of the present invention is accessed online via a customer interface 101 that is presented on an interactive electronic display, such as a tablet or a vehicle's entertainment system and in-car display, as illustrated in FIG. 2.

The customer interface 101 is preferably connected to the Internet 102 via cellular or a local wireless connection provided by a seller or dealer selling a primary product to the customer, such as a car dealer selling a car to the customer. A first server 103 controlled by the service provider is communicatively connected to the customer interface 101. At least one database 104 is connected to said first server 103.

A dealer server 105 is communicatively connected to the customer interface 101 wherein the connection between said insurance dealer server 105 and the customer interface 101 is controlled by said first server 103.

An insurance provider server 106 controlled by an insurance provider, such as an insurance agent or broker, is communicatively connected to the customer interface 101 wherein the connection between said insurance provider server 106 and the customer interface 101 is controlled by said first server 103.

With reference to FIGS. 2 and 2A, exemplary views of a customer interface 201 of the present invention being presented on an electronic display 202 in a vehicle dashboard 203 are illustrated. The interactive electronic device 204 may be a credit card processing terminal, video display, tablet or may also comprise a vehicle's entertainment system 205 wherein an electronic video display 202 in the entertainment system 205 has touchscreen or equivalent controls used for selecting icons and/or entering information through the electronic display 202.

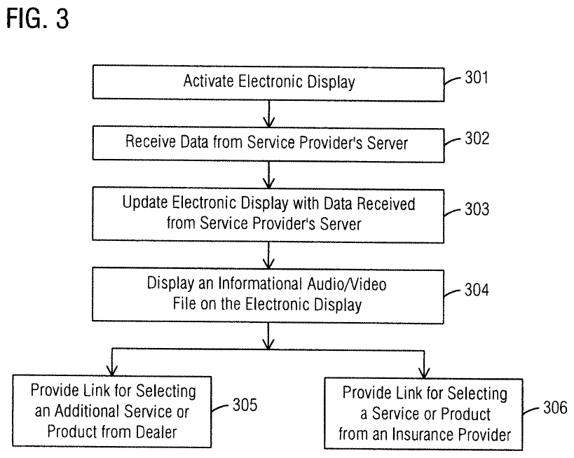

The interactive electronic device 204 is preferably connected to the Internet via cellular or a local wireless connection provided by the dealer. After being shown an informational audio/video clip, as described in FIG. 3, the customer is presented with at least one selection comprising at least one dealer hyperlink 205 connected to at least one site having informational and/or interactive selections relating to further products and services offered by the dealer. After being shown an informational audio/video clip, as described in FIG. 3, the customer is also presented with at least one selection comprising an insurance provider hyperlink 206 connected to at least one site having informational and/or interactive selections relating to further products and services offered by an insurance provider.

With reference to FIG. 3, a flow chart showing initial steps for carrying out the system and method of the present invention are illustrated. First, an electronic display is activated and presented by a dealer to a customer purchasing a product from the dealer 301. For example, a car dealer may present the customer with a tablet or seat the customer in a vehicle being purchased wherein the system and method of the present invention is carried out though the vehicle's entertainment system, as illustrated in FIG. 2. After activating the electronic display 301, the electronic display receives data from the service provider server 302 and the electronic display is updated with said received data 303 to display at least one informational video relating to the product being purchased 304.

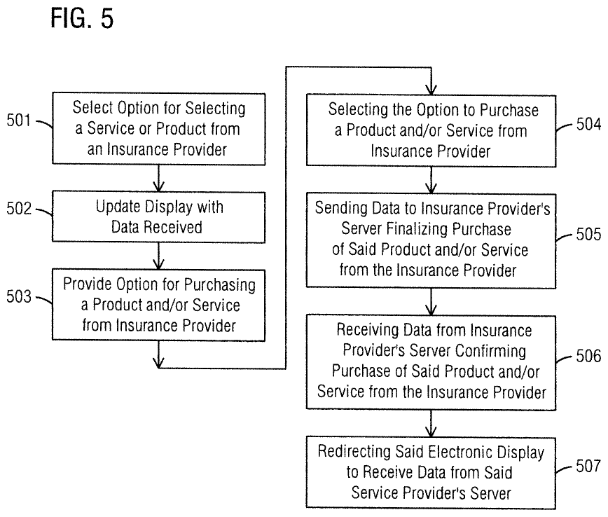

After the at least one informational video is displayed, at least selection comprising a dealer hyperlink connected to at least one site having informational and/or interactive selections relating to further products and services offered by the dealer is presented on the electronic display 305 as further described in FIG. 5.

In addition, an insurance provider hyperlink connected to at least one site having informational and/or interactive selections relating to further products and services offered by a third-party professional is presented on the electronic display 306 as further described in FIG. 5.

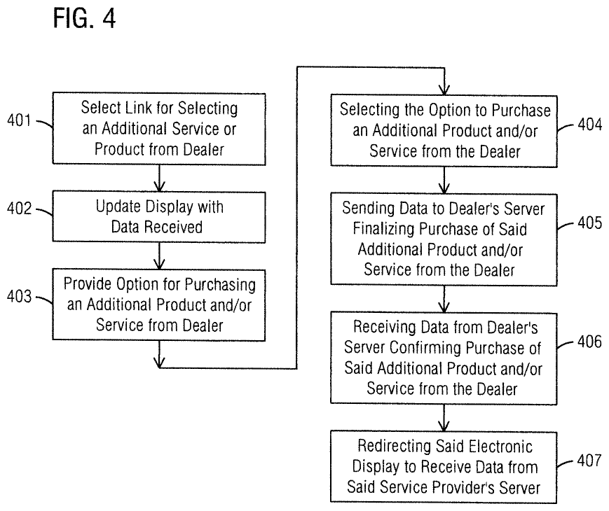

With reference to FIG. 4, a flowchart showing steps for carrying out the system and method of the present invention after a customer has selected a dealer hyperlink is illustrated. After selecting a dealer hyperlink 401, data is received from the dealer's server to update the electronic display with data relating to a desired product or service 402. Then, an option for purchasing a desired product and/or service from the dealer is presented to the customer via the electronic interface and display 403, which may be selected by the customer 404. Afterward, data is sent to the service provider server 405 and received 406 to finalize a purchase of the desired product and/or service from the dealer. Then, the electronic display is redirected to receive data from said service provider server comprising at least one selection option for selecting an insurance provider hyperlink connected to at least one site having informational and/or interactive selections relating to further products and services offered by an insurance provider is presented on the electronic display 407 and as further described in FIGS. 5 and 6.

With reference to FIG. 5., a flowchart showing steps for carrying out the system and method of the present invention after a customer has selected an insurance provider hyperlink is illustrated. After selecting an insurance provider hyperlink 501 the electronic display is updated with data relating to a desired product or service 502, such as vehicle insurance. Then, an option for purchasing a desired product and/or service from the insurance provider is presented to the customer via the electronic interface and display 503, which may be selected by the customer 504. Afterward, data is sent to the insurance provider's server 505 and received 506 to finalize a purchase of the desired product and/or service from the insurance provider. Then, the electronic display is redirected to receive data from said service provider server comprising at least one selection option for selecting a dealer hyperlink connected to at least one site having informational and/or interactive selections relating to further products and services offered by said dealer and/or through said dealer 507 and as further described in FIG. 6.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

Having thus described my invention, I claim:

1. A method for providing a Graphical User Interface (GUI) within a vehicle for effectuating the purchase of one or more products that are unique to the vehicle, the method comprising:
coupling, by a processor, a GUI to a vehicle wherein a plurality of variables unique to the vehicle are programmed into a memory that is in communication with the processor and the GUI;
receiving, by the processor, a request for a product entered through the GUI wherein the product is unique to the plurality of variables programmed into the GUI;
evaluating, by the processor, available products stored on a remote server;
determining, by the processor, a product that matches one or more of the variables programmed into the GUI;
altering, by the processor, said product to match one or more of the variables programmed into the GUI;
visualizing, by the processor, the product through an associated product display element on the GUI; and
executing, by the processor, a purchase the product represented by the associated product display on the GUI.

2. A computer system for providing a graphical user interface (GUI) and processor for vehicles, said system comprising:
a memory configured to store instructions and a plurality of variables unique to the vehicle;
a processor disposed in communication with said memory, wherein said processor upon execution of instructions is configured to receive a request for a product wherein the product is unique to the plurality of variables programmed into the memory;
said processor upon execution of instructions is configured to evaluating, by the processor, available products stored on a remote server;
said processor upon execution of instructions is configured to match one or more of the variables programmed into the GUI;
said processor upon execution of instructions is configured to alter said product to match one or more of the variables programmed into the GUI;
said processor upon execution of instructions is configured to visualize the product through an associated product display element on a graphical user interface installed in said vehicle; and
said processor upon execution of instructions is configured to execute a purchase the product represented by the associated product display on the GUI.
